(19) United States
(12) Patent Application Publication
(10) Pub. No.: US 2020/0186746 A1
(43) Pub. Date: Jun. 11, 2020

(54) PROTECTIVE DISPLAY MONITOR COVER AND METHOD OF MAKING THE SAME

(71) Applicant: Panasonic Avionics Corporation, Lake Forest, CA (US)

(72) Inventors: Feng Jiang, Irvine, CA (US); Shrenik Shah, San Juan Capistrano, CA (US)

(21) Appl. No.: 16/211,585

(22) Filed: Dec. 6, 2018

(51) Int. Cl. H04N 5/64; B29C 45/14; B32B 17/06; B32B 7/12

(52) U.S. Cl. CPC H04N 5/64; B29C 45/14434; B29L 2031/3475; B32B 17/064; B32B 7/12; B29C 45/14631

(57) ABSTRACT

A protective display monitor cover for safeguarding a display monitor from injury caused by broken glass from the display monitor. The cover includes a substantially transparent glass panel configured to cover the active display area of the display monitor. The cover has a rim attached to, and surrounding the perimeter, of the glass panel. The exterior surface of the glass panel is flush with the front surface of the rim. A transparent film is applied on, and adhered to, the exterior surface of the glass panel and the front surface of the rim. The film extends sufficiently onto the front surface of the rim such that the film remains adhered to the rim upon an impact to the glass panel which breaks the glass panel, thereby containing any broken glass from the cover and/or display monitor from escaping the cover.

### BACKGROUND

The field of the invention generally relates to on-board display monitors, such as seat-back mounted display monitors for vehicles, and more particularly, to protective covers for display monitors which protect passengers from head impact injury.

Typically, entertainment systems for vehicles have video displays installed at each passenger seat. For instance, video displays are provided at each passenger seat, such as mounted at each of the seatbacks of the passenger seats, and/or on cabin walls and/or deployable from an armrest for seats located at a bulkhead, i.e., in the first row of a section. Many of these systems allow each passenger to select from multiple video channels and/or audio channels, or even individually select and play videos from a library of videos. These video displays may also provide access to games, communication applications (e.g., telephone service, messaging, etc.), internet browsing, and other computer applications. Sometimes such displays are referred to as smart monitors due to the ability to provide computer applications and process and store data internally.

Such entertainment systems may be installed, and are currently utilized, on a variety of vehicles, including commercial passenger aircraft, passenger trains, automobiles, buses. For instance, many commercial passenger aircraft have in-flight entertainment system (“IFE”) having video displays located at each passenger seat.

The display monitors utilized in on-board entertainment systems generally include glass screens and/or other components which can present a risk of injury to a passenger in the event the display monitor is broken. For example, if there is a head impact on the display monitor, the glass screen can be broken and the broken glass can injure a passenger. Indeed, for on-board, in-flight entertainment systems on airplanes, there are rules and/or regulations regarding protection from injury caused by head impact with a display monitor. One such regulation is referred to as Head Impact Criteria (HIC) promulgated by the Federal Aviation Administration (FAA). One of the criteria of the HIC requires that material that can cause a cut must be contained during an impact with the display monitor. Another criteria of the HIC specifies the amount of acceptable impact caused by the collision of a passenger with the display monitor.

Several designs for safeguarding display monitors have been previously disclosed. For example, U.S. Patent Application Publication No. US 2016/0297526 A1 discloses a delethalization cover which attaches to the front of a display monitor. The delethalization cover is formed of tempered glass, such that it provides a higher strength barrier which prevents glass from reaching a passenger in the event of the passenger's head impacting the cover and/or breaking the display monitor. However, the delethalization cover is heavy and relatively thick in order to provide sufficient strength and also does not contain the broken tempered glass in the event it does break due to an impact.

U.S. Pat. No. 9,411,452 also discloses a system for safeguarding a display monitor in the event of an impact. The system includes a monitor cover comprising a translucent panel having a frangible region which breaks away from the remainder of the panel upon an impact. Accordingly, the panel absorbs an impact by breaking in a safe, predictable manner, rather than shattering or forming shards.

### SUMMARY

In one embodiment, the present invention is directed to an innovative display monitor cover for safeguarding a display monitor (e.g., a display monitor having a glass screen), such as preventing injury caused by a broken display monitor in the event of an impact to the display monitor. For instance, the display monitor cover may allow the display monitor assembly, including the display monitor and the cover, to meet the requirements of HIC set forth by the FAA.

The display monitor cover comprises a glass panel configured to cover an active display area of a display monitor. The glass panel has an interior surface which faces the display monitor and an exterior surface facing away from the display monitor, when the cover is mounted over the display monitor. The display monitor cover has a rim surrounding the perimeter of the glass panel. The rim has a front surface facing away from the display monitor when the cover is mounted over the display monitor. The rim interface between the exterior surface of the glass panel and the front surface of the rim is flush such that the exterior surface of the glass panel is flush with the front surface of the rim. In other words, there is not a step where the glass panel meets the rim.

The rim has a width extending outward from the interface with the glass panel. The rim is configured to be mounted over the display monitor. In one way, the rim is configured to be mounted to the front of the display monitor. For instance, the rim may be configured to be mounted to a front bezel of the display monitor, such as by adhesive, glue, fasteners, etc.

The display monitor cover also has a film applied and adhered to the exterior surface of the glass panel and extending onto, and adhered to the front surface of the rim. The film extends sufficiently onto the front surface of the rim such that the film remains adhered to the rim upon an impact to the glass panel which breaks the glass panel. The film may be adhered to the glass panel and the rim using pressure sensitive adhesive, or other suitable adhesive.

Accordingly, when mounted over a display monitor, the display monitor cover creates an enclosed space over the display monitor which contains any broken glass from both the glass panel and the glass screen of the display monitor and prevents such broken glass from exiting out of the enclosed space.

In another aspect, the display monitor cover may further comprise a reinforcing rod disposed in the rim. The reinforcing rod may extend along the entire rim, or any portion of the rim. In still another aspect, the rim may be formed of plastic and may be injection molded onto the reinforcing rod.

In yet another feature, the rim may be injection molded onto the glass panel such that the rim interface between the exterior surface of the glass panel and the front surface of the rim is flush. In other words, the exterior surface of the glass panel is flush with the front surface of the rim.

In still another feature, the exterior surface of the glass panel is beveled along an outer perimeter of the glass panel at the interface with the rim, and the front surface of the rim extends over the bevel such that the front surface of the rim is flush with the exterior surface of the glass. The bevel and the rim extending over the bevel provides mechanical retention of the glass panel to the rim.

In another embodiment, the present invention is directed to an innovative method of manufacturing a display monitor cover for safeguarding a display monitor (e.g., a display monitor having a glass screen). The method comprises insert-injection molding a rim onto a glass panel. The glass panel has a perimeter, an interior surface which faces the display monitor and an exterior surface facing away from the display monitor when the cover is mounted over the display monitor. The resulting rim has a front surface which faces away from the display monitor when the cover is mounted over the display monitor. The glass panel is inserted into an injection mold tool and the rim is injection molded onto the glass panel such that the rim surrounds a perimeter of the glass panel and the exterior surface of the glass panel is flush with the front surface of the rim (i.e., the rim interface between the exterior surface of the glass panel and the front surface of the rim is flush).

A film is applied and adhered to the exterior surface of the glass panel and the front surface of the rim such that the film extends from the exterior surface of the glass onto the front surface of the rim. The film extends sufficiently onto the front surface of the rim such that the film remains adhered to the rim upon an impact to the glass panel which breaks the glass panel. The film may be adhered to the glass panel and the rim using pressure sensitive adhesive, or other suitable adhesive.

In another aspect of the method, the rim is also insert-injection molded onto a reinforcing rod which extends along the rim. The reinforcing rod is inserted into the injection molding tool, along with the glass panel, and the rim is injection molded onto the reinforcing rod and the glass panel. Again, the rim surrounds the perimeter of the glass panel and the rim interface between the exterior surface of the glass panel and the front surface of the rim is flush such that the exterior surface of the glass panel is flush with the front surface of the rim.

### BRIEF DESCRIPTION OF THE DRAWINGS

FIG. 1 is a top perspective view of a display monitor cover, according to one embodiment of the present invention;

FIG. 2 is bottom perspective view of the display monitor cover of FIG. 1, according to one embodiment of the present invention;

FIG. 3 is top perspective, partial-cutaway view of the display monitor cover of FIG. 1, according to one embodiment of the present invention;

FIG. 4 is an enlarged, top, perspective, partial-cutaway view of a portion of the display monitor cover of FIG. 1, according to one embodiment of the present invention.

FIG. 5 is an enlarged, top, perspective, partial-cutaway view of a portion of the display monitor cover of FIG. 1, according to one embodiment of the present invention.

FIG. 6 is a top perspective view of the display monitor cover of FIG. 1 depicting a broken main (glass) panel, according to one embodiment of the present invention;

FIG. 7 is a side, perspective, exploded view of an assembly of a display monitor and the display monitor cover of FIG. 1, according to one embodiment of the present invention; and

FIG. 8 illustrates a flow chart of a method of making a display monitor cover, according to another embodiment of the present invention.

### DETAILED DESCRIPTION

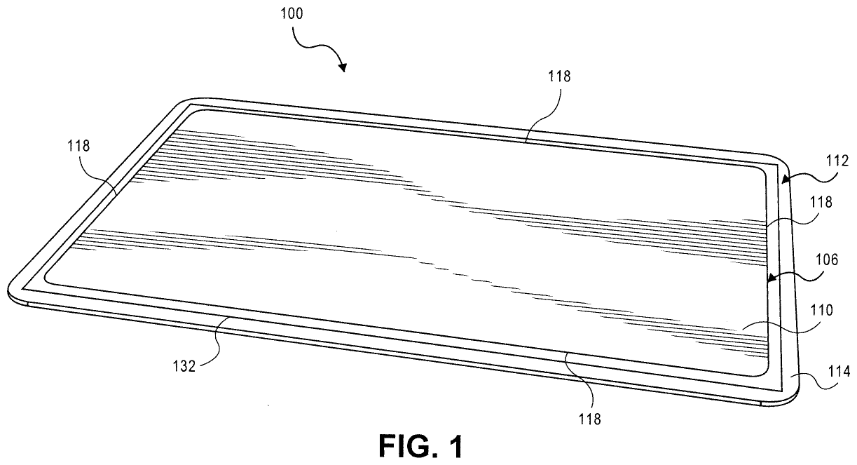

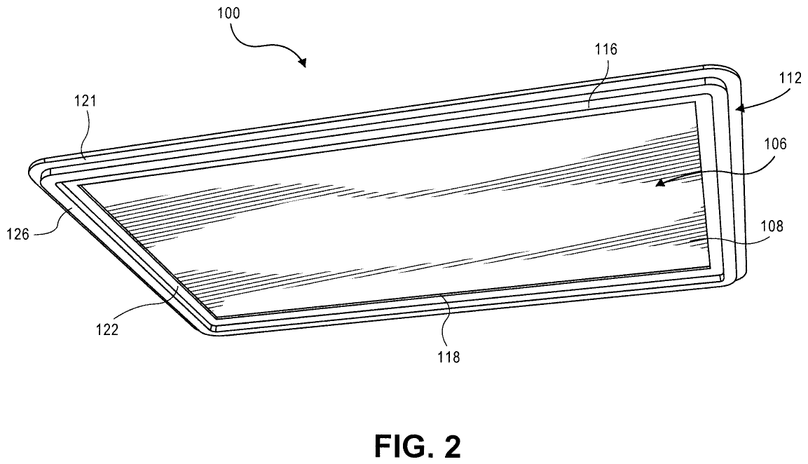

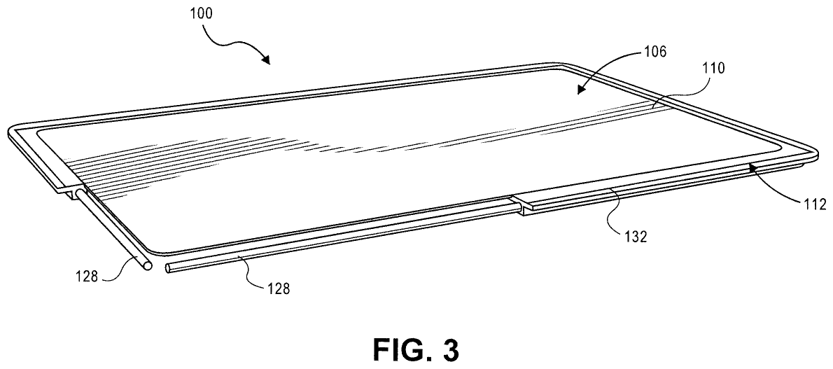

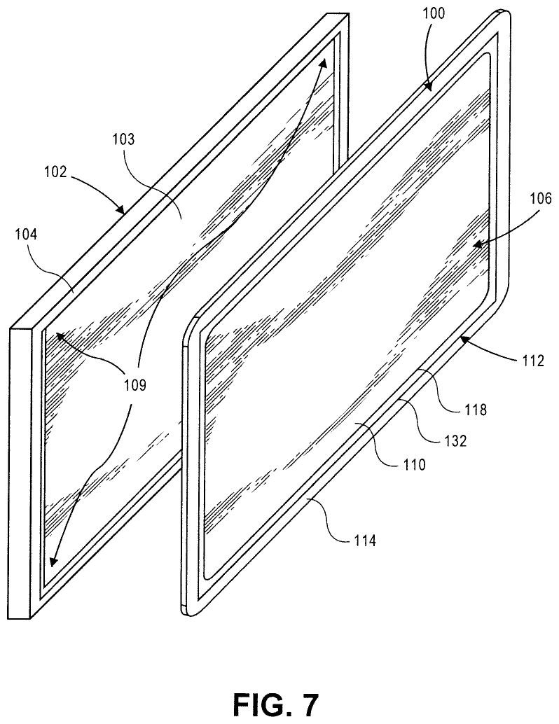

Referring to FIGS. 1-5, one embodiment of a protective display monitor cover 100 is illustrated. The display monitor cover 100 is configured to be mounted over a display monitor 102, as depicted in FIG. 7. For example, the display monitor cover 100 may be configured to be mounted to the front bezel 104 of the display monitor 102, such as by adhesive, glue, fasteners, or other suitable means of mounting the display monitor cover 100 to the display monitor 102. Alternatively, the display monitor cover 100 may be configured to be mounted to a housing, enclosure, bracket, or other structure such that the cover 100 is positioned in front of the display monitor 102. For example, for a seatback mounted display monitor 102, the display monitor cover 100 may be configured to be mounted to a housing, enclosure, or bracket installed in the seatback, such that the display monitor cover 100 covers the display monitor 102 as mounted in the seatback.

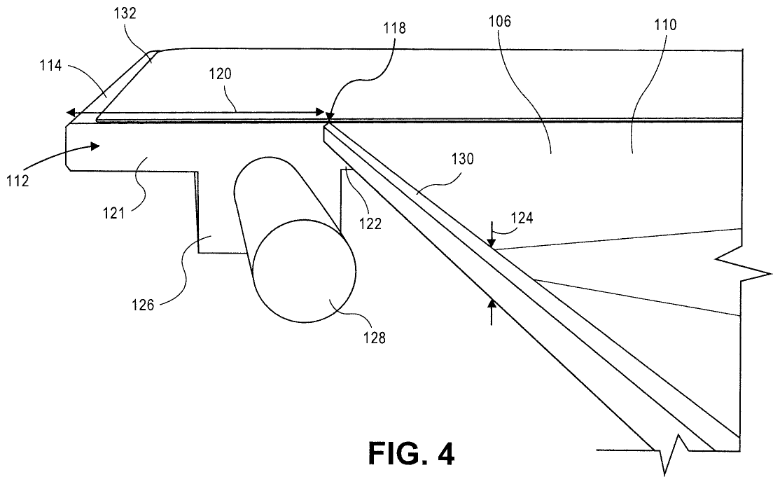

The display monitor cover 100 comprises a main panel 106. The main panel 106 may be formed of any suitable, substantially transparent or translucent material which allows the display monitor 102 to be viewed through the main panel 106. As some examples, the main panel may be made of glass, coated glass, colored glass, or the like. The main panel 106 is sized and shaped to cover an active display area 109 of the display monitor 102. The main panel 106 has an interior surface 108 which faces the display monitor 102 and an exterior surface 110 facing away from the display monitor 102, when the cover 102 is mounted over the display monitor 102 (see FIG. 7). The main panel 106 may have a thickness 122 (see FIG. 4) in the range of 1.0-1.5 mm, for glass. If the main panel 106 is formed of alternative materials, such as polycarbonate or other plastic material, the main panel may be thick such that it has a stiffness and/or strength similar to the glass main panel 106, e.g., in the range of 1.5-2.5 mm.

The display monitor cover 102 has a rim (or frame) 112 surrounding the perimeter of the main panel 106. The rim 112 may surround, and be attached to, the entire perimeter of the main panel 106, or any portion of the main panel 106 sufficient to securely attach the rim 112 to the main panel 106. The rim 112 may be formed of any suitable material, such as plastic, metal, or the like. The rim 112 has a front surface 114 facing away from the display monitor 102 when the cover 100 is mounted over the display monitor 102, and a rear surface 116 facing towards the display monitor 102 when the cover 100 is mounted over the display monitor 102.

The front surface 114 of the rim 112 interfaces with the exterior surface 110 of the perimeter of the main panel 106 at a rim interface 118. The rim interface 118 between the front surface 114 of the rim 112 and the exterior surface 110 of the main panel 106 is flush such that the front surface 114 of the rim 112 is flush with exterior surface 110 of the main panel 106. As used herein, the term “flush” means that adjacent surfaces are even or level and in direct contact with each other.

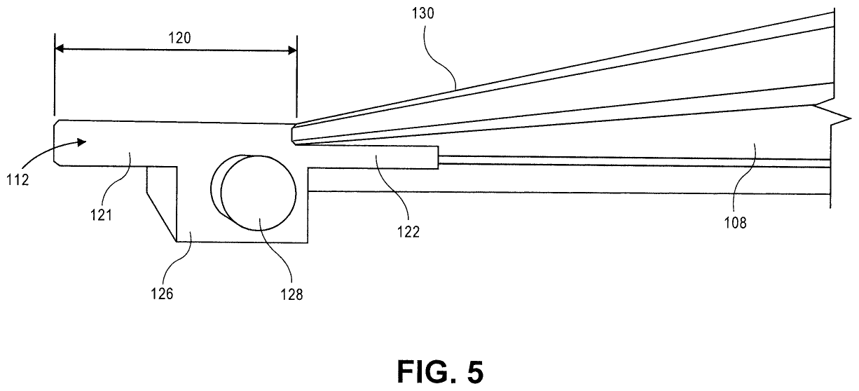

As shown in FIGS. 4 and 5, the rim 112 may have a T-shaped cross-section. A first part 121 of the arm of the T-shaped cross-section of the rim 112 has a lateral width 120 extending outward from the rim interface 118. A second part 122 of the arm of the T-shaped cross-section of the rim 112 forms a recessed ledge 122 extending inward from the rim interface 118. The outer edge of the interior surface 108 of the main panel 106 rests on, and may be attached to, the recessed ledge 122. The recessed ledge 122 is recessed from the front surface 114 of the rim 112 and the thickness 124 of the main panel 106, so that the exterior surface 110 of the main panel 106 is flush with the front surface 114 of the rim 112. The bar 126 of the T-shaped cross-section extends rearwardly from the arm. The bar 126 provides structure to the rim 112 for embedding a reinforcing rod 128 into the rim 112. The reinforcing rod 128 extends along the entire rim 112. The reinforcing rod 128 may be a single, integral rod, or multiple rods attached to each other. Alternatively, the reinforcing rod 128 may be formed of multiple rods which extend along respective portions of the rim 112. The reinforcing rod 128 may have a circular cross-section, a square cross-section, a rectangular cross-section, an I-beam cross-section, or other suitable cross-section. The reinforcing rod 128 may be formed of metal, such as steel or aluminum, to increase the stiffness and strength of the rim 112.

As shown in FIGS. 4 and 5, the main panel 106 has a beveled edge 130 extending along the entire perimeter of the exterior surface 110 of the main panel 106. The rim 112 extends onto the beveled edge 130 thereby mechanically retaining the main panel 106 on the rim 112, and vice versa. In other words, the main panel 106 is mechanically retained on the rim 112 between the rim 112 extending onto the beveled edge 130 and the recessed ledge 122.

Referring to FIGS. 1, 3 and 5, the display monitor cover 100 has a film 132 applied to the exterior surface 110 of the main panel 106 and the front surface 114 of the rim 112. In other words, the film 132 extends from the exterior surface 110 of the main panel 106 onto the front surface 114 of the rim 112. The film 132 is applied to the entire exterior surface 110 of the main panel 106. The film 132 is adhered to both the exterior surface 110 of the main panel 106 and the front surface 114 of the rim 112. The film 132 may be a substantially transparent or translucent polymeric film, such as polyethylene terephthalate (PET) film, or other suitable film. The film 132 may have a thickness in the range of 0.005 inches to 0.01 inches. The film 132 is adhered to the exterior surface 110 of the main panel 106 and the front surface 114 of the rim 112 using a pressure sensitive adhesive.

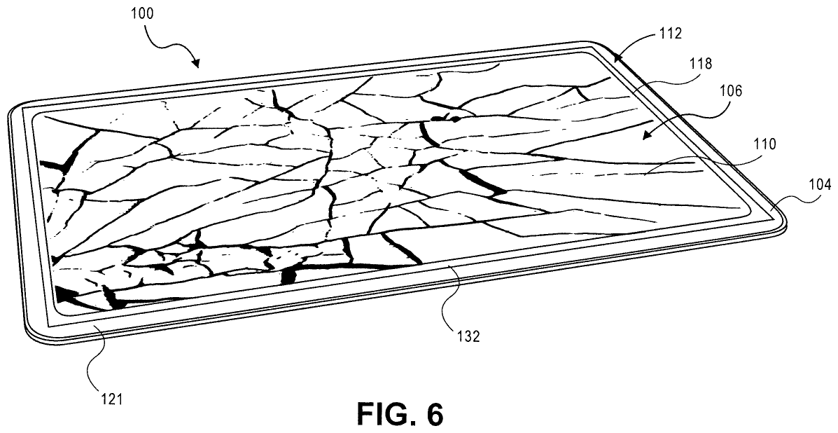

The film 132 extends a sufficient width onto the front surface 114 of the rim 112 such that the film 132 remains adhered to the rim 112 upon an impact to the main panel 106 which breaks the main panel 106, as depicted in FIG. 6. For instance, the film 132 may extend onto the front surface 114 of the rim 112 by at least 0.25 inches, or at least 0.5 inches, or in a range of from 0.25 inches to 0.715 inches, or in a range of from 0.1 inches to 0.75 inches. Hence, upon an impact to the main panel 106 which breaks the main panel 106, the film 132 contains the broken pieces of the main panel 106 from escaping past the film 132.

As depicted in FIG. 7, when mounted over the display monitor 102, the display monitor cover 100 creates an enclosed space over the display monitor 102 which contains any broken pieces (e.g., broken glass) from both the main panel 106 and the glass screen 103 of the display monitor 102 and prevents the broken pieces from exiting out of the enclosed space.

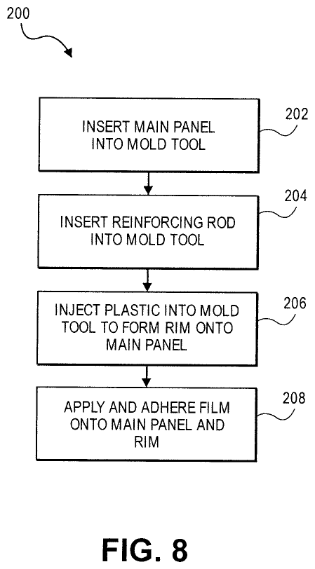

Referring now to FIG. 8, a flow chart of one embodiment of a method 200 of manufacturing the display monitor cover 100 for safeguarding a display monitor (e.g., a display monitor having a glass screen) is shown. The method 200 is an insert-injection molding process in which the rim 112 of the cover 100 is injection molded onto a main panel 106 and a reinforcing rod 128. At step 202, the main panel 106 is inserted into an injection mold tool. At step 204, the reinforcing rod 128 is inserted into the injection mold tool. At step 206, plastic material is injected into the injection mold tool such that the rim 112 is injection molded onto the main panel 106 and the reinforcing rod 128. The injection molded rim 112 surrounds the perimeter of the main panel 106 with the rim interface 118 between the exterior surface 110 of the main panel 106 and the front surface 114 of the rim 112 flush. In addition, the injection molding forms the bar 126 of the rim 112 which embeds the reinforcing rod 128 in the bar 126 of the rim 112. The injection molding of the rim 112 onto the main panel 106 may also form a chemical bond between the recessed ledge 122 of the rim 112 and the main panel 106, as well as the rim 112 extending over the beveled edge 130 of the main panel 106 which provides mechanical retention of the main panel 106 to the rim 112.

At step 208, a film 132 is applied to the exterior surface 110 of the main panel 106 and the front surface 114 of the rim 112. The film 132 is adhered to the exterior surface 110 of the glass panel 106 and the front surface 114 of the rim 112 using a pressure sensitive adhesive. The film 132 extends sufficiently onto the front surface 114 of the rim 112 such that the film 132 remains adhered to the rim 112 upon an impact to the main panel 106 which breaks the main panel 106 into broken pieces.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. Accordingly, embodiments are intended to exemplify alternatives, modifications, and equivalents that may fall within the scope of the claims. The invention, therefore, should not be limited, except to the following claims, and their equivalents.

What is claimed is:

1. A display monitor cover for mounting over a display monitor having an active display area, the display monitor cover comprising:
a substantially transparent main panel sized and shaped to cover the active display area, the main panel having an outer perimeter, and an interior surface which faces the display monitor and an exterior surface facing away from the display monitor, when the display monitor cover is mounted over the display monitor;
a rim surrounding the outer perimeter of the main panel, the rim having a front surface facing away from the display monitor when the display monitor cover is mounted over the display monitor, wherein the front surface of the rim and the exterior surface of the main panel are flush with each other at a rim interface between the front surface and the exterior surface; and
a substantially transparent film applied to the exterior surface of the main panel and the front surface of the rim such that the film extends from the exterior surface of the main panel onto the front surface of the rim, the film adhered to both the exterior surface of the main panel and the front surface of the rim, the film extending onto the front surface of the rim a sufficient width such that the film remains adhered to the rim upon an impact to the main panel which breaks the main panel.

2. The display monitor cover of claim 1, wherein the main panel is made of glass.

3. The display monitor cover of claim 1, wherein the main panel is made of glass, and the rim is made of plastic injection molded onto the main panel.

4. The display monitor cover of claim 1, wherein the main panel has a beveled edge at the exterior surface along the outer perimeter, and the rim extends over the beveled edge.

5. The display monitor cover of claim 1, further comprising a reinforcing rod disposed in the rim.

6. The display monitor cover of claim 5, wherein the reinforcing rod extends along the entire length of rim.

7. The display monitor cover of claim 6, wherein the reinforcing rod is a single, integral rod.

8. The display monitor cover of claim 1, wherein the film extends onto the front surface of the rim by a width of at least 0.25 inches.

9. The display monitor cover of claim 1, wherein the film extends onto the front surface of the rim a width of from 0.25 inches to 0.75 inches.

10. A display monitor cover for mounting over a display monitor having an active display area, the display monitor cover comprising:
a substantially transparent glass panel sized and shaped to cover the active display area, the glass panel having an outer perimeter, and an interior surface which faces the display monitor and an exterior surface facing away from the display monitor, when the display monitor cover is mounted over the display monitor;
a rim surrounding the outer perimeter of the glass panel, the rim formed of plastic injection molded onto the glass panel, the rim having a front surface facing away from the display monitor when the display monitor cover is mounted over the display monitor, wherein the front surface of the rim and the exterior surface of the glass panel are flush with each other at a rim interface between the front surface and the exterior surface; and
a substantially transparent, polyethylene terephthalate (PET) film applied to the exterior surface of the glass panel and the front surface of the rim such that the film extends from the exterior surface of the glass panel onto the front surface of the rim, the film adhered to both the exterior surface of the glass panel and the front surface of the rim, the film extending onto the front surface of the rim a sufficient width such that the film remains adhered to the rim upon an impact to the glass panel which breaks the glass panel.

11. The display monitor cover of claim 10, wherein the main panel has a beveled edge at the exterior surface along the outer perimeter, and the rim extends over the beveled edge.

12. The display monitor cover of claim 10, further comprising a reinforcing rod disposed in the rim.

13. The display monitor cover of claim 12, wherein the reinforcing rod extends along the entire length of rim.

14. A method of manufacturing a display monitor cover, the method comprising:
inserting a substantially transparent main panel into an injection mold tool, the main panel sized and shaped to cover the active display area, the main panel having an outer perimeter, an interior surface which faces the display monitor and an exterior surface facing away from the display monitor, when the display monitor cover is mounted over the display monitor;
injecting plastic material into the injection mold tool such that the rim is injection molded onto the main panel, the rim surrounding the outer perimeter of the main panel, the rim having a front surface facing away from the display monitor when the display monitor cover is mounted over the display monitor, wherein the front surface of the rim and the exterior surface of the main panel are flush with each other at a rim interface between the front surface and the exterior surface;
applying a transparent film to the exterior surface of the main panel and the front surface of the rim such that the film extends from the exterior surface of the main panel onto the front surface of the rim, the film adhered to both the exterior surface of the main panel and the front surface of the rim, the film extending onto the front surface of the rim a sufficient width such that the film remains adhered to the rim upon an impact to the main panel which breaks the main panel.

15. The method of claim 14, further comprising:
inserting a reinforcing rod into the injection mold tool prior to injecting plastic material into the injection mold tool; and
wherein injecting plastic into material into the injection mold tool embeds the reinforcing rod into the rim.

16. The display monitor cover of claim 15, wherein the reinforcing rod extends along the entire length of rim.

17. The method of claim 14, wherein the main panel is made of glass.

18. The method of claim 14, wherein the main panel has a beveled edge at the exterior surface along the outer perimeter, and the rim extends over the beveled edge.

19. The method of claim 14, wherein the film extends onto the front surface of the rim by a width of at least 0.25 inches.

20. The method of claim 14, wherein the film extends onto the front surface of the rim a width of from 0.25 inches to 0.75 inches.
